(19) United States
(12) Patent Application Publication
(10) Pub. No.: US 2016/0378457 A1
(43) Pub. Date: Dec. 29, 2016

(54) PROGRAM UPDATE SYSTEM AND PROGRAM UPDATE METHOD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Naoki ADACHI, Yokkaichi, Mie (JP); Akinori USAMI, Yokkaichi, Mie (JP); Masashi WATANABE, Yokkaichi, Mie (JP); Tetsuya NODA, Yokkaichi, Mie (JP)

(21) Appl. No.: 15/038,944

(22) PCT Filed: Nov. 26, 2014
(86) PCT No.: PCT/JP2014/081139

§ 371 Date: May 24, 2016

(30) Foreign Application Priority Data
Nov. 27, 2013 (JP) 2013-245083

(51) Int. Cl. G06F 9/445; H04L 29/06; H04L 29/08

(52) U.S. Cl. CPC G06F 8/65; H04L 67/34; H04L 63/0876; H04L 63/123

(57) ABSTRACT

A program update system and method that are able to verify the legitimacy of an update of a program executed on a vehicle side. An exterior device stores update data including an update control program for a control device targeted for updating and a computer program that implements means for calculating a digest value relating to the update control program, means for determining whether operation of the control device after the update is normal, and means for transmitting a result of the determination as a response. The control device to receives the update data that is transmitted from the exterior device via a relay device and updates the control program using the update control program included in the update data, and determines whether operation after the update is normal and transmits a result of the determination to the relay device by executing the computer program.

### TECHNICAL FIELD

The present invention relates to a program update system and a program update method that verify the legitimacy of an update of a program executed on a vehicle side.

### BACKGROUND ART

In the automotive field in recent years, vehicles have become increasingly sophisticated, with a diverse range of devices being installed in vehicles, requiring the installation of large numbers of control devices, so-called ECUs (Electronic Control Units), for controlling these vehicle-mounted devices. Various types of ECUs are installed in vehicles such as, for example, body-type ECUs that control interior lighting, turn headlights on/off, sound alarms and the like according to switch operations and the like by someone in the vehicle, meter-type ECUs that control the operation of various meters that are arranged in the vicinity of the driver's seat, and navigation-type ECUs that control car navigation devices and the like.

Generally, ECUs are constituted by a processor such as a microcomputer, and control of vehicle-mounted devices is implemented by reading and executing control programs stored in a ROM (Read Only Memory). The control programs may differ depending on the destination point where the vehicle will be operated and the functions that are installed, even with the same model of vehicle, giving rise to the need to rewrite control programs in accordance with the destination point and installed functions, and to rewrite old versions of control programs with new versions of control programs in response to control program upgrades.

Patent Document 1 discloses an automotive control device installed in a vehicle that, in the case where it is confirmed that data received through wireless communication is data transmitted to the automotive control device, rewrites data stored in a nonvolatile memory with the received data.

### CITATION LIST

### Patent Documents

Patent Document 1: JP H05-195859A

### SUMMARY OF INVENTION

### Technical Problem

However, in the case of adopting a configuration that enables control programs of vehicle-mounted devices to be added or updated, programs that malicious third parties have created could possibly be added and executed. Information that is transmitted and received over an in-vehicle network, for example, could thereby be leaked by unauthorized programs.

The present invention was made in view of these circumstances, and has an object to provide a program update system and a program update method that are able to verify the legitimacy of an update of a program executed on a vehicle side.

### Solution to Problem

A program update system according to the present invention is a system that includes a plurality of control devices provided with storage means for storing a control program for controlling a vehicle-mounted device and execution means for reading out and executing the control program, a relay device connected to the plurality of control devices via an in-vehicle communication line, and an exterior device connected to the relay device via an exterior communication network and for storing update data required in order to update the control program, and in which the update data is transmitted from the exterior device to the relay device, and the control program stored in the storage means of the control device is updated, based on the update data received by the relay device. The update data is provided with an update control program for a control device targeted for updating and a computer program that implements means for calculating a digest value relating to the update control program, means for determining whether operation of the control device after the update is normal, and means for transmitting a result of the determination by the determining means to the relay device as a response. The relay device is provided with means for transmitting the update data received from the exterior device to the control device targeted for updating, and the control device is provided with means for receiving the update data transmitted from the relay device and means for updating the control program stored in the storage means using the update control program included in the received update data. Also, the control device, by executing the computer program included in the update data, determines whether operation after the update is normal and transmits a result of the determination to the relay device as a response.

In the program update system according to the present invention, the relay device may be provided with means for storing device identification information identifying the control devices connected via the in-vehicle communication line and program identification information identifying the control programs stored in the storage means of the control devices, and means for transmitting the device identification information of the control device storing a control program targeted for updating and the program identification information of the control program to the exterior device, and the exterior device may be provided with means for receiving the device identification information and program identification information transmitted from the relay device, means for specifying update data to be transmitted to the relay device, based on the received device identification information and program identification information, and means for adding the device identification information and the program identification information when transmitting the specified update data to the relay device.

In the program update system according to the present invention, the relay device may be provided with means for acquiring a digest value relating to the update control program, means for encrypting the acquired digest value, and means for transmitting the encrypted digest value to the exterior device, and the exterior device may be provided with means for receiving the encrypted digest value transmitted from the relay device, means for decrypting the received digest value, means for comparing the decrypted digest value with an expected value stored in advance, and means for determining a legitimacy of a post-update control program in the control device, based on a result of the comparison.

In the program update system according to the present invention, the exterior device may be provided with means for retransmitting stored update data and the computer program to the control device via the relay device, if it is judged that the post-update control program is not legitimate.

In the program update system according to the present invention, the exterior device may be provided with means for notifying the control device via the relay device to terminate execution of the control program, if it is judged that the post-update control program is not legitimate, and the control device may be provided with means for terminating execution of the control program, if a notification indicating to terminate execution of the control program is received from the exterior device.

In the program update system according to the present invention, at least one of the exterior device, the relay device, and the control device may include means for holding the pre-update control program, the exterior device may be provided with means for notifying the control device via the relay device to restore the pre-update control program if it is judged that the post-update control program is not legitimate, and the control device may be provided with means for acquiring the pre-update control program, if a notification to restore the pre-update control program is received via the relay device, and means for restoring the post-update control program stored in the storage means to the acquired pre-update control program.

A program update method according to the present invention is a method in which an exterior device transmits, to a relay device connected to a control device including storage means for storing a control program for controlling a vehicle-mounted device and execution means for reading out and executing the control program, update data required in order to update the control program, and the control program stored in the storage means of the control device is updated, based on the update data received by the relay device. The update data includes an update control program for a control device targeted for updating, and a computer program that implements means for calculating a digest value relating to the update control program, means for determining whether operation of the control device after the update is normal, and means for transmitting a result of the determination by the determining means to the relay device as a response. The relay device transmits the update data received from the exterior device to the control device targeted for updating, and the control device receives the update data transmitted from the relay device, updates the control program stored in the storage means using the update control program included in the received update data, and by executing the computer program included in the update data, determines whether operation after the update is normal and transmits a result of the determination to the relay device as a response.

With the present invention, an exterior device stores, as update data required in order to update a control program stored in a control device, update data including an update control program for a control device targeted for updating and a computer program that implements means for calculating a digest value relating to the update control program, means for determining whether operation of the control device after the update is normal, and means for transmitting a result of the determination as a response, and transmits the update data to the control device via a relay device. The control device updates the control program based on the update control program that is included in the received update data, and, by executing the computer program that is included in the update data, determines whether operation after the update is normal and transmits a result of the determination to the relay device as a response.

In the present invention, the computer program can be packaged in update data for updating a control program, making it difficult to tamper with the computer program, compared to the case where the computer program is prepackaged in the control device. Also, the legitimacy of an updated control program is secured by the relay device or the exterior device communicably connected to the relay device verifying the legitimacy of a digest value of the update control program.

In the present invention, the relay device manages the device identification information of control devices and the program identification information of control programs, and thus the exterior device is able to specify the update target by acquiring the device identification information of the control device targeted for updating and the program identification information of the control program targeted for updating from the relay device.

In the present invention, the relay device encrypts the digest value transmitted from the control device and transmits the encrypted digest value to the exterior device, and thus tampering with the digest value while the digest value is being transmitted over the communication channel is prevented.

In the present invention, update data and the computer program are retransmitted if it is judged that the post-update control program is not legitimate, and thus bugs in the control program as a result of missing bits or the like are prevented.

In the present invention, execution of the control program is terminated if it is judged that the post-update control program is not legitimate, and thus operation of a vehicle-mounted device by a control program that has been tampered with is prevented.

In the present invention, the pre-update control program is restored if it is judged that the post-update control program is not legitimate, and thus it is at least possible to secure operation of the pre-update control device.

### Advantageous Effects of Invention

According to the instant invention, a computer program that implements means for calculating a digest value relating to an update control program, means for determining whether operation after the update is normal, and means for transmitting a result of the determination to a relay device as a response is packaged in update data for updating a control program, making it difficult to tamper with the computer program, compared to the case where the computer program is prepackaged in the control device. Also, since the computer program can be created on the update data distribution side, the expected value for the digest value can be changed each time updating is performed, enabling tampering and spoofing to be prevented.

Also, the relay device or the exterior device communicably connected to the relay device is able to check that the computer program is operating normally by verifying the digest value that is output from the control device, enabling the legitimacy of the updated control program to be secured.

### BRIEF DESCRIPTION OF DRAWINGS

FIG. 1 is a schematic diagram showing the configuration of a program update system according to an embodiment.

FIG. 2 is a block diagram showing the internal configuration of a gateway.

FIG. 3 is a block diagram illustrating the internal configuration of an ECU.

FIG. 4 is a block diagram illustrating the internal configuration of a server device.

FIG. 5 is a flowchart showing the procedure of processing that the server device executes.

FIG. 6 is a flowchart showing the procedure of processing that is executed by a vehicle.

FIG. 7 is a flowchart showing the procedure of processing for verifying a digest value.

### DESCRIPTION OF EMBODIMENTS

Hereinafter, the present invention will be specifically described based on drawings that show embodiments of the invention.

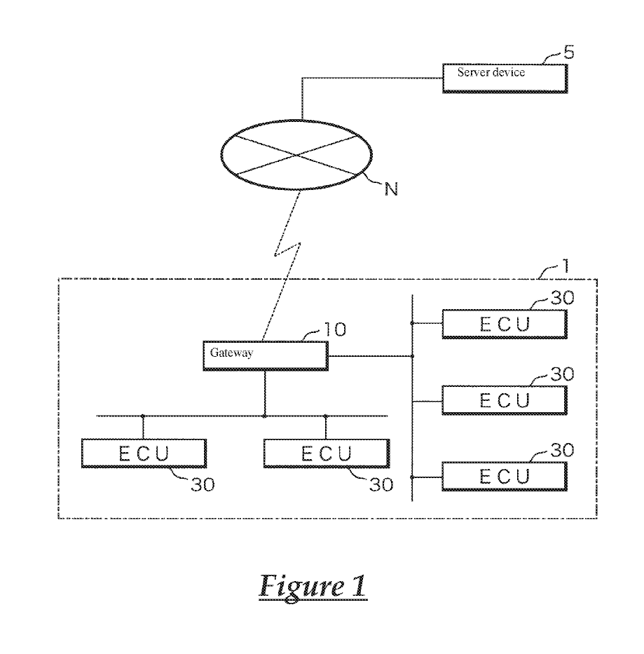

FIG. 1 is a schematic diagram showing the configuration of a program update system according to the present embodiment. Reference sign 1 shown with a dotted-dashed line in the diagram denotes a vehicle, and a gateway 10 and a plurality of ECUs 30 are installed in the vehicle 1. A plurality of communication groups formed by the plurality of ECUs 30 connected by a bus to a common communication line are provided in the vehicle 1, and the gateway 10 relays communication between the communication groups. A plurality of communication lines are thus connected to the gateway 10. Also, the gateway 10 is communicably connected to a wide-area wireless network N such as a public mobile phone network, and is configured to transmit information received from an exterior device such as a server device 5 to the ECUs 30 through the wide-area wireless network N, and to transmit information acquired from the ECUs 30 to the exterior device via the wide-area wireless network N.

Note that, in the present embodiment, a configuration is adopted in which the gateway 10 communicates directly with the exterior device, but a configuration may be adopted in which a communication device is connected to the gateway 10 and the gateway 10 communicates with the exterior device via the connected communication device. The communication device connected to the gateway 10 includes devices such as a mobile phone, a smart phone, a tablet-type terminal and a notebook PC (Personal Computer) possessed by a user, for example.

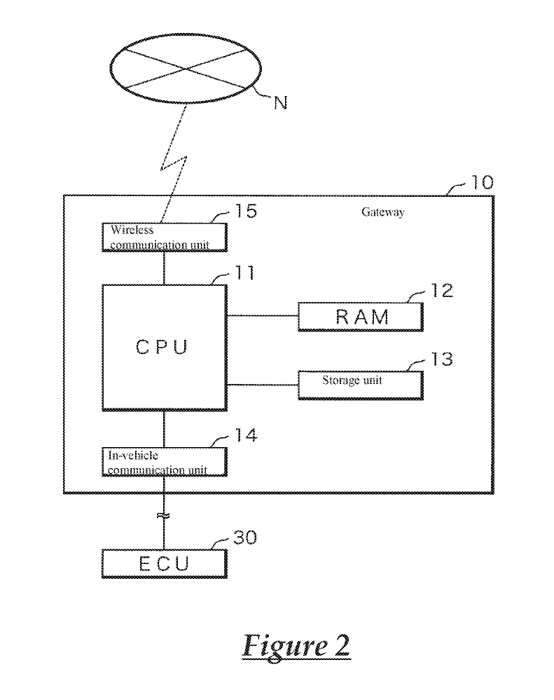

FIG. 2 is a block diagram showing the internal configuration of the gateway 10. The gateway 10 is constituted by being provided with a CPU (Central Processing Unit) 11, a RAM (Random Access Memory) 12, a storage unit 13, an in-vehicle communication unit 14, a wireless communication unit 15, and the like.

The CPU 11 causes the gateway 10 to function as a relay device according to the present invention, by reading out one or more programs stored in the storage unit 13 to the RAM 12, and executing the read one or more programs. The CPU 11 is able to execute a plurality of programs in parallel by switching between and executing the plurality of programs by time sharing or the like, for example. The RAM 12 is constituted by a memory element such as an SRAM (Static RAM) or a DRAM (Dynamic RAM), and temporarily stores programs to be executed by the CPU 11, data required in executing the programs, and the like.

The storage unit 13 is constituted using a nonvolatile memory element such as a flash memory or an EEPROM (Electrically Erasable Programmable Read Only Memory), or using a magnetic storage device such as a hard disk, or the like. The storage unit 13 has a storage area that stores programs to be executed by the CPU 11, data required in executing the programs, and the like.

The plurality of ECUs 30 are connected to the in-vehicle communication unit 14 via communication lines arranged within the vehicle 1. The in-vehicle communication unit 14 communicates with the ECUs 30 according to a standard such as CAN (Controller Area Network), LIN (Local Interconnect Network), Ethernet (registered trademark), or MOST (Media Oriented Systems Transport), for example. The in-vehicle communication unit 14 transmits information provided from the CPU 11 to targeted ECUs 30, and provides information received from the ECUs 30 to the CPU 11. The in-vehicle communication unit 14 may also communicate by other communication standards that are used on the in-vehicle network, apart from the above communication standards.

The wireless communication unit 15 is, for example, constituted using an antenna and an attached circuit that executes processing related to communication using the antenna, and has a function of connecting to the wide-area wireless network N, which is a public cellular-phone network or the like, and executing communication processing. The wireless communication unit 15 transmits information provided from the CPU 11 to an exterior device such as the server device 5, and provides information received from the exterior device to a CPU 31, via the wide-area wireless network N, which is formed by a base station that is not shown in the diagrams.

Note that a configuration may be adopted in which the gateway 10 is provided with a wired communication unit for connecting the above-mentioned communication device, instead of the wireless communication unit 15. This wired communication unit has a connector that connects the communication device via a communication cable that conforms to a standard such as USB (Universal Serial Bus) or RS-232C, and communicates with the communication device connected via the communication cable. The wired communication unit transmits information provided from the CPU 11 to the exterior device connected to the wide-area wireless network N by wireless communication, and provides information received from the exterior device to the CPU 11 through the wide-area wireless network N.

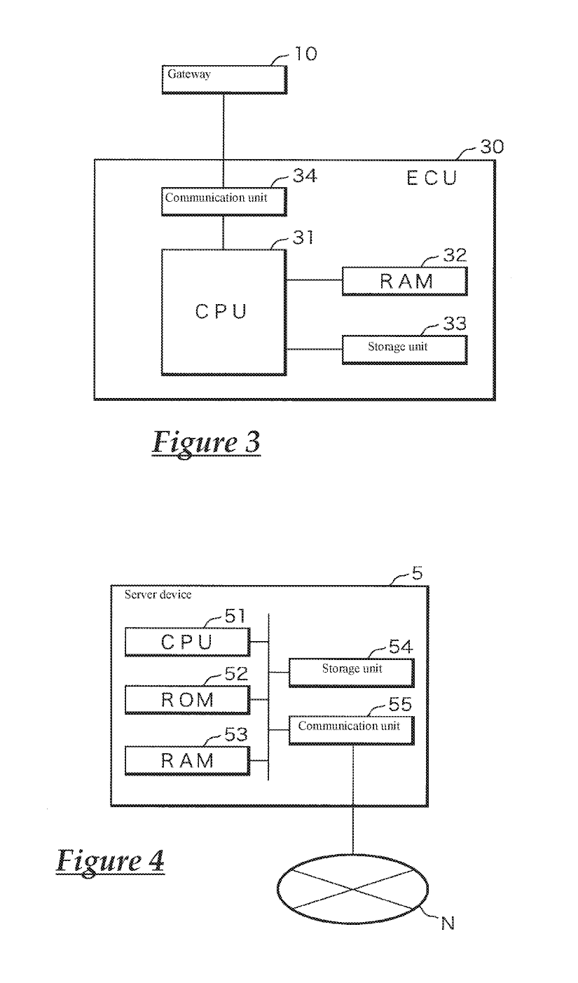

FIG. 3 is a block diagram illustrating the internal configuration of an ECU 30. The ECU 30 is, for example, provided with the CPU 31, a RAM 32, a storage unit 33, a communication unit 34 and the like, and controls various vehicle-mounted devices that are not shown in the diagrams.

The CPU 31 controls the operations of the above-mentioned hardware and causes the ECU 30 to function as a control device according to the present invention, by reading out one or more programs pre-stored in the storage unit 33 to the RAM 32 and executing the read one or more programs. The RAM 32 is constituted by a memory element such as an SRAM or a DRAM, and temporarily stores programs to be executed by the CPU 31, data required in executing the programs, and the like.

The storage unit 33 is constituted using a nonvolatile memory element such as a flash memory or an EEPROM, or using a magnetic storage device such as a hard disk, or the like. The information that is stored in the storage unit 33 includes, for example, a computer program (hereinafter, control program) for causing the CPU 31 to execute processing for controlling a vehicle-mounted device targeted for control.

The gateway 10 is connected to the communication unit 34 via a communication line arranged in the vehicle 1. The communication unit 34 communicates with the gateway 10 according to a standard such as CAN (Controller Area Network), LIN (Local Interconnect Network), Ethernet (registered trademark) or MOST (Media Oriented Systems Transport), for example. The communication unit 34 transmits information provided from the CPU 31 to the gateway 10, and provides information received from the gateway 10 to the CPU 31. The communication unit 34 may communicate by other communication standards that are used on the in-vehicle network, apart the above communication standards.

FIG. 4 is a block diagram illustrating the internal configuration of the server device 5. The server device 5 is provided with a CPU 51, a ROM 52, a RAM 53, a storage unit 54, a communication unit 55 and the like, for example.

The CPU 51 controls the operations of the above-mentioned hardware and causes the server device 5 to function as an exterior device according to the present invention, by reading out one or more programs pre-stored in the ROM 52 to the RAM 53 and executing the read one or more programs. The RAM 53 is constituted by a memory element such as an SRAM or a DRAM, and temporarily stores programs to be executed by the CPU 51, data required in executing the programs, and the like.

The storage unit 54 is constituted using a nonvolatile memory element such as a flash memory or an EEPROM, or using a magnetic storage device such as a hard disk, or the like. The information that is stored in the storage unit 54 includes, for example, update data required in order to update the control programs that are executed by the ECUs 30 installed in the vehicle 1.

The update data includes an update control program that executes control for partially or entirely rewriting the control program that is stored by an ECU 30 targeted for updating.

Also, a computer program (hereinafter, response program) to be executed by an ECU 30 whose control program has been updated is stored in the update data. The response program is constituted as a computer program that causes an ECU 30 to function as means for calculating a digest value relating to the update control program, means for determining whether operation after the update is normal, and means for transmitting a result of the determination to the gateway 10 as a response.

The communication unit 55 includes a processing circuit that executes processing related to communication, for example, and has a function of connecting to the wide-area wireless network N, which is a public cellular-phone network or the like, and executing communication processing. The communication unit 55 transmits information provided from the CPU 51 to an external device via the wide-area wireless network N, and provides information received via the wide-area wireless network N to the CPU 51.

Hereinafter, the updating procedure of a control program will be described.

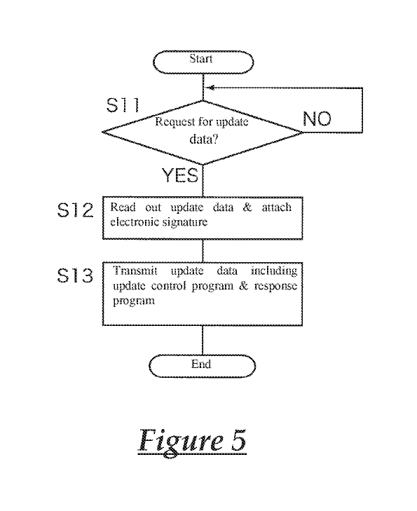

FIG. 5 is a flowchart showing the procedure of processing that the server device 5 executes. It is assumed that update data (reprogramming data) for updating control programs that are executed by the ECUs 30 on the vehicle 1 side is stored in the storage unit 54 of the server device 5 in association with version numbers of the control programs. The CPU 51 of the server device 5 judges whether a request for update data to which the vehicle number of the vehicle 1, the serial number of the ECU 30 targeted for updating and the version number of the control program targeted for updating are attached has been received from the gateway 10 of the vehicle 1 (step S11). If the request has not been received (S11: NO), the CPU 51 stands by until the request is received from the gateway 10 of the vehicle 1.

If the request has been received (S11: YES), the CPU 51 reads out the update data to be transmitted from the storage unit 54, and attaches an electronic signature of the CA (Certification Authority) or the corresponding OEM (Original Equipment Manufacturer) to the read update data (step S12). Next, the CPU 51 transmits the update data to which the electronic signature has been attached and that includes the above-mentioned update control program and response program through the communication unit 55 to the gateway 10 of the vehicle 1 that is provided with the ECU 30 targeted for updating (step S13).

Note that, in the processing procedure shown in FIG. 5, a configuration is adopted in which the ECU 30 targeted for updating is specified with reference to the vehicle number, the serial number of the ECU 30 and the version number of the control program that are attached to the request for update data, but a configuration may be adopted in which the vehicle number of the vehicle 1, the serial numbers of the ECUs 30 and the version numbers of the control programs that are installed in the ECUs 30 are stored in the storage unit 54 of the server device 5 in association with one another, and the ECU 30 targeted for updating is specified from the server device 5 side.

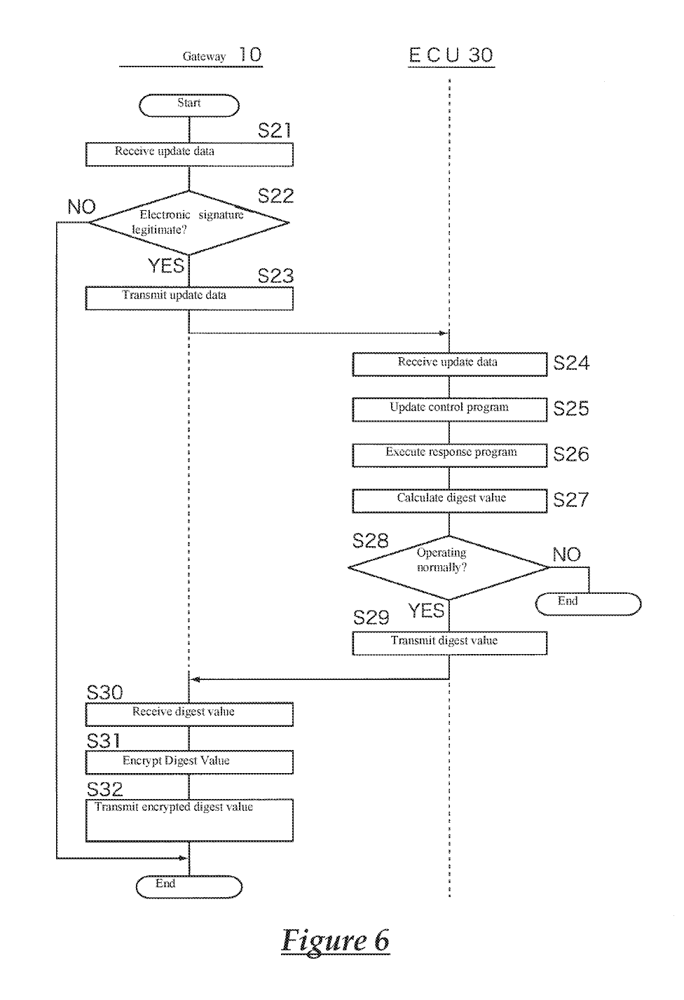

FIG. 6 is a flowchart showing the procedure of processing that is executed by the vehicle 1. If update data that is transmitted from the server device 5 is received by the wireless communication unit 15 of the gateway 10 (step S21), the CPU 11 of the gateway 10 judges whether the electronic signature relating to the received update data is legitimate (step S22). The gateway 10, by acquiring a digital certificate from the certification authority or each OEM in advance, is able to judge whether the electronic signature is legitimate using the digital certificate.

If it is judged that the electronic signature of the update data received from the server device 5 is not legitimate (S22: NO), the CPU 11 ends the processing of this flowchart.

If it is judged that the electronic signature of the update data received from the server device 5 is legitimate (S22: YES), the CPU 11 transmits the received update data to the ECU 30 targeted for updating via the in-vehicle communication unit 14 (step S23).

If the update data that is transmitted from the gateway 10 is received by the communication unit 34 of the ECU 30 (step S24), the CPU 31 of the ECU 30 reads the update control program that is included in the received update data into the RAM 32 and executes the update control program, and executes processing (reprogramming) for updating the control program that is stored in the storage unit 33 (step S25).

OSGi (Open Services Gateway initiative) technology, for example, can be employed in updating control programs. OSGi is a system that manages dynamic addition, execution and the like of programs that are called bundles, and is constituted such that an OSGi framework, which is the execution base of bundles, operates in the CPU 31. Note that since OSGi is an existing technology, a detailed description is omitted. Also, the CPU 31 may update control programs, employing a technology other than OSGi.

If updating of the control program is completed, the CPU 31 of the ECU 30 reads the response program that is included in the update data into the RAM 32 and executes the response program (step S26), and causes the ECU 30 to function as means for calculating a digest value relating to the update control program, means for determining whether operation after the update is normal, and means for transmitting a result of the determination to the gateway 10.

The CPU 31 of the ECU 30 that executed the response program calculates a digest value for the update control program (step S27). The digest value that the CPU 31 calculates may be a digest value (hash value) derived by a known hash function, or may be a digest value derived by another algorithm such as MD5. Also, in the case where the update control program is constituted by a program group composed of a plurality of programs, the digest value may be calculated from only a predetermined program. The digest value may be calculated from programs including the post-update control program. Note that it is assumed that the range for calculating the digest value is defined by the response program.

Next, the CPU 31 operates a basic function of the ECU 30 and determines whether the device it belongs to (the ECU 30 itself) operates normally (step S28). If it is determined that the device it belongs to operates normally (S28: YES), the CPU 31 transmits the digest value calculated at step S27 to the gateway 10 through the communication unit 34, together with a result of the determination (step S29). Also, if the device it belongs to does not operate normally (S28: NO), the CPU 31 ends the processing of this flowchart.

If the CPU 11 of the gateway 10 receives a result of the determination and the digest value that are transmitted from the ECU 30 with the in-vehicle communication unit 14 (step S30), the received digest value is encrypted (step S31), and the encrypted digest value is transmitted to the server device 5 through the wireless communication unit 15 (step S32).

Note that, in the present embodiment, a configuration is adopted in which a digest value of the update control program is calculated in the ECU 30 and, if it is judged that the ECU 30 is operating normally, the calculated digest value is transmitted to the gateway 10, but a configuration may be adopted in which it is determined whether the ECU 30 is operating normally using the post-update control program, and only processing for transmitting a result of the determination to the gateway 10 as a response is executed. In this case, a configuration may be adopted in which the gateway 10, upon receiving a response indicating that the ECU 30 is operating normally from the ECU 30, calculates the digest value from the update control program that is included in the update data received at step S21, and after having encrypted the calculated digest value, transmits the encrypted digest value to the server device 5.

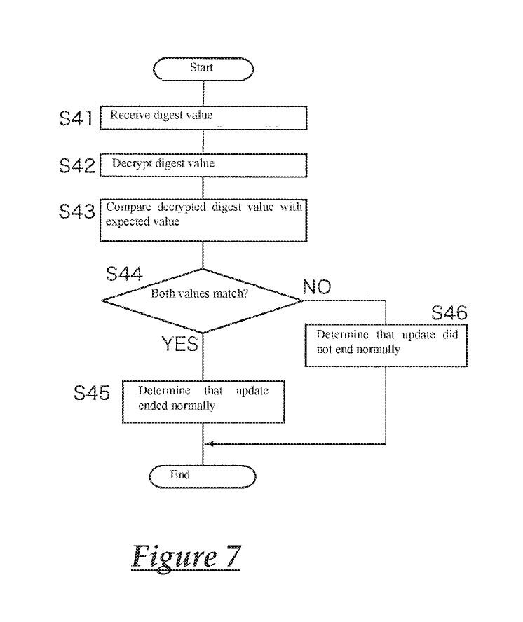

FIG. 7 is a flowchart showing the procedure of processing for verifying a digest value. The CPU 51 of the server device 5, in the case of the encrypted digest value that was transmitted from the gateway 10 of the vehicle 1 having been received with the communication unit 55 (step S41), decrypts the encrypted digest value (step S42). Note that a known technique such as a public key encryption scheme can be used as the technique for encrypting the digest value in the gateway 10 and decrypting the encrypted digest value in the server device 5.

Next, the CPU 51 of the server device 5 compares the decrypted digest value with the expected value pre-stored in the storage unit 54 (step S43), and judges whether the two values match (step S44).

If it is judged that the two values match (S44: YES), the CPU 51 determines that updating of the control program has ended normally in the ECU 30 targeted for updating (step S45). Also, if it is judged that the two values do not match (S44: NO), the CPU 51 determines that updating of the control program in the ECU 30 was not normal (step S46).

If updating of the control program in the ECU 30 was not normal, the server device 5 may be configured to resend update data stored in the storage unit 54 to the ECU 30.

Also, because operations not intended by the distribution source of the control program could possibly be executed by the ECU 30 in the case where updating of the control program in the ECU 30 was not normal, a configuration may be adopted in which a notification instructing that the control program be terminated is notified from the server device 5 to the vehicle 1 side, and the control program is terminated.

Furthermore, in the case where updating of the control program in the ECU 30 was not normal, the server device 5 may be configured to transmit a notification indicating to restore the pre-update control program to the ECU 30 via the gateway 10, so as to restore the post-update control program stored in the storage unit 33 of the ECU 30 to the pre-update control program. Note that the pre-update control program may be held in one of the storage unit 54 of the server device 5, the storage unit 13 of the gateway 10, and the storage unit 33 of the ECU 30. In the case where the ECU 30 receives the notification that is transmitted from the server device 5, it is possible to restore the original state by the ECU 30 acquiring the pre-update control program from one of its own storage unit 33, the storage unit 13 of the gateway 10 and the storage unit 54 of the server device 5, and rewriting the post-update control program to the pre-update control program.

As described above, in the instant invention, a computer program (response program) that causes processing for calculating a digest value of the control program, processing for determining whether the ECU 30 is operating normally, and processing for transmitting the digest value to the gateway 10 if the ECU 30 is operating normally to be executed can be packaged in update data for updating a control program, thus making it difficult to tamper with the response program, compared to the case where the response program is prepackaged in the ECU 30. Also, since the response program can be created on the update data distribution side, the expected value for the digest value can be changed each time updating is performed, enabling tampering and spoofing to be prevented.

The presently disclosed embodiments are considered in all respects to be illustrative and not restrictive. The scope of the invention is indicated by the appended claims rather than the foregoing description, and all changes that come within the meaning and range of equivalence thereof are intended to be embraced therein.

REFERENCE SIGNS LIST

1 Vehicle

10 Gateway

11 CPU

12 RAM

13 Storage unit

14 In-vehicle communication unit

15 Wireless communication unit

30 ECU

31 CPU

32 RAM

33 Storage unit

34 Communication unit

5 Server device

51 CPU

52 ROM

53 RAM

54 Storage unit

55 Communication unit

1. A program update system comprising:
a plurality of control devices including:
storage means for storing a control program for controlling a vehicle-mounted device; and
execution means for reading out and executing the control program;
a relay device connected to the plurality of control devices via an in-vehicle communication line; and
an exterior device connected to the relay device via an exterior communication network and for storing update data required in order to update the control program, and
in which the update data is transmitted from the exterior device to the relay device, and the control program stored in the storage means of the control device is updated, based on the update data received by the relay device,
wherein the update data includes:
an update control program for a control device targeted for updating; and
a computer program that implements:
means for calculating a digest value relating to the update control program;
means for determining whether operation of the control device after the update is normal; and
means for transmitting a result of the determination by the determining means to the relay device as a response,
the relay device includes:
means for transmitting the update data received from the exterior device to the control device targeted for updating,
the control device includes:
means for receiving the update data transmitted from the relay device; and
means for updating the control program stored in the storage means using the update control program included in the received update data, and
the control device, by executing the computer program included in the update data, determines whether operation after the update is normal, and transmits a result of the determination to the relay device as a response.

2. The program update system according to claim 1,
wherein the relay device includes:
means for storing device identification information identifying the control devices connected via the in-vehicle communication line, and program identification information identifying the control programs stored in the storage means of the control devices; and
means for transmitting the device identification information of the control device storing a control program targeted for updating and the program identification information of the control program to the exterior device, and
the exterior device includes:
means for receiving the device identification information and program identification information transmitted from the relay device;
means for specifying update data to be transmitted to the relay device, based on the received device identification information and program identification information; and
means for adding the device identification information and the program identification information when transmitting the specified update data to the relay device.

3. The program update system according to claim 1,
wherein the relay device includes:
means for acquiring a digest value relating to the update control program;
means for encrypting the acquired digest value; and
means for transmitting the encrypted digest value to the exterior device, and
the exterior device includes:
means for receiving the encrypted digest value transmitted from the relay device;
means for decrypting the received digest value;
means for comparing the decrypted digest value with an expected value stored in advance; and
means for determining a legitimacy of a post-update control program in the control device, based on a result of the comparison.

4. The program update system according to claim 3,
wherein the exterior device includes:
means for retransmitting stored update data and the computer program to the control device via the relay device, if it is judged that the post-update control program is not legitimate.

5. The program update system according to claim 3,
wherein the exterior device includes:
means for notifying the control device via the relay device to terminate execution of the control program, if it is judged that the post-update control program is not legitimate, and
the control device includes:
means for terminating execution of the control program, if a notification indicating to terminate execution of the control program is received from the exterior device.

6. The program update system according to claim 3,
wherein at least one of the exterior device, the relay device, and the control device includes means for holding the pre-update control program,
the exterior device includes:
means for notifying the control device via the relay device to restore the pre-update control program if it is judged that the post-update control program is not legitimate, and
the control device includes:
means for acquiring the pre-update control program, if a notification to restore the pre-update control program is received via the relay device; and
means for restoring the post-update control program stored in the storage means to the acquired pre-update control program.

7. A program update method in which an exterior device transmits, to a relay device connected to a control device including storage means for storing a control program for controlling a vehicle-mounted device and execution means for reading out and executing the control program, update data required in order to update the control program, and the control program stored in the storage means of the control device is updated, based on the update data received by the relay device,
wherein the update data includes:
an update control program for a control device targeted for updating; and
a computer program that implements:
means for calculating a digest value relating to the update control program;
means for determining whether operation of the control device after the update is normal; and
means for transmitting a result of the determination by the determining means to the relay device as a response,
the relay device:
transmits the update data received from the exterior device to the control device targeted for updating, and
the control device:
receives the update data transmitted from the relay device,
updates the control program stored in the storage means using the update control program included in the received update data, and
by executing the computer program included in the update data, determines whether operation after the update is normal, and
transmits a result of the determination to the relay device as a response.

8. The program update system according to claim 2,
wherein the relay device includes:
means for acquiring a digest value relating to the update control program;
means for encrypting the acquired digest value; and
means for transmitting the encrypted digest value to the exterior device, and
the exterior device includes:
means for receiving the encrypted digest value transmitted from the relay device;
means for decrypting the received digest value;
means for comparing the decrypted digest value with an expected value stored in advance; and
means for determining a legitimacy of a post-update control program in the control device, based on a result of the comparison.
